(19) United States
(12) Patent Application Publication
(10) Pub. No.: US 2009/0242217 A1
(43) Pub. Date: Oct. 1, 2009

(54) FIRE RESISTANT MATERIAL AND METHODS OF USE THEREOF

(75) Inventor: Gijsbert van de Loenhorst, JD Kootwijkerbroek (NL)

Correspondence Address: THE NATH LAW GROUP, 112 South West Street, Alexandria, VA, 22314, US

(73) Assignee: FireFabric B.V.i.o., TN Arnhem (NL)

(21) Appl. No.: 12/058,558

(22) Filed: Mar. 28, 2008

(51) Int. Cl. A62C 2/06; B32B 5/02; B32B 3/02; A62C 8/06

(52) U.S. Cl. 169/46; 442/136; 428/190; 169/48

(57) ABSTRACT

A fire protection layer is provided which includes a fabric of relatively pliant fibers and a fire resistant coating comprising silicone. The relatively pliant fibers may be selected from the group comprising glass fibers, polyester fibers and cotton fibers. The fire protection layer may be used in a fire protection blanket. Such a fire protection blanket may comprise a central part and a relatively lighter peripheral edge part. The fire protection layer may also be bonded to one or more structural layers to form a laminated structural fire protection material. Also provided is a method of extinguishing a burning object, comprising the steps of providing a fire protection blanket having a central part and a peripheral edge part, arranging the fire protection blanket over the burning object such that the peripheral edge part contacts an area surrounding the burning object, and smothering the fire.

### FIELD OF THE INVENTION

The present invention relates to a fire protection layer. In particular, the invention relates to a fire protection layer for use in fire protection blankets and in laminated structural materials. The invention further relates to the use of such fire protection blankets in a method of extinguishing a burning object.

### BACKGROUND OF THE INVENTION

Fires are traditionally extinguished by dousing the flames with water, extinguisher foam or powder. However, this traditional approach has some drawbacks. When the burning object is a vehicle parked in a car park, the use of water, foam or powder to extinguish the fire may easily lead to collateral damage to surrounding vehicles. Moreover, when a traveling vehicle catches fire and has to be extinguished on the road, the road or at least one or more lanes may have to be closed off following the fire in order to allow the water, foam or powder to be removed. This may further lead to environmental problems.

In order to obviate or at least minimize these drawbacks, it has already been proposed to use fire protection blankets for extinguishing fires by smothering the flames.

U.S. Pat. No. 6,125,941 to Lokken already discloses a blanket for smothering fires or protecting items from fire. This prior art blanket comprises a wettable polymer capable of high volume water retention, a water reservoir and heat activatable valves to permit water to flow from the reservoir to wet the polymer through gravity fed conduits. The blanket is also provided with a frame or other support to keep it in place over a fire. Due to this frame and because this prior art blanket relies on water for its fire smothering effect, it is relatively heavy and complicated in use. Therefore, this blanket is not suitable for extinguishing fires in confined spaces, for instance when a vehicle catches fire in a car park.

Dutch patent NL 1021213 discloses a fire protection blanket that is intended for extinguishing vehicles on fire. The blanket is provided with tubes running along its edges, which are filled with water to hold the blanket down over the vehicle to be extinguished. This prior art blanket therefore requires the use of water, which is said to be taken either from a fire fighting vehicle or from a hydrant. This renders use of the fire protection blanket rather complex, while filling the tubes with water further takes additional time.

### SUMMARY AND OBJECTS OF THE INVENTION

Accordingly, it is an object of the present invention therefore to provide an improved fire protection blanket, that is relatively light and easy to use and that does not require any ancillary equipment.

It is another object of the invention to provide a fire protection layer that will allow a lightweight yet effective fire protection blanket to be made.

Still another object of the invention is to provide a fire resistant laminated structural material, for instance for use in walls of buildings or hulls of vessels or aircraft.

Finally, the invention has for its object to propose a method of extinguishing a fire in a confined area, like a burning vehicle in a car park.

In accordance with a first aspect of the invention, a fire protection layer is provided. This layer includes a fabric of relatively pliant fibers and a fire resistant coating that renders the fabric impermeable. The coating comprises silicone, and may preferably further comprise one or more minerals. The relatively pliant fibers may advantageously be selected from the group comprising glass fibers, polyester fibers or cotton fibers.

According to a second aspect of the invention, a fire protection blanket is provided which comprises at least one fire protection layer of the type described above. In a preferred embodiment, this fire protection blanket comprises a central part and a peripheral edge part, wherein the peripheral edge part is relatively lighter than the central part. This may be the result of the central part having a greater thickness than the peripheral edge part, e.g. by arranging a greater number of fire protection layers in the central part than in the peripheral edge part. Alternatively, the fabric of the fire protection layer in the central part may be more densely woven than that in the peripheral edge part.

In order to allow the fire protection blanket to withstand repeated fires before having to be discarded, the central part preferably has a specific mass of at least 150 g/m², more preferably at least 300 g/m², and most preferably at least 400 g/m².

The central part is preferably connected to the peripheral edge part by stitches including fire resistant thread, so as to avoid these parts becoming disconnected due to the intense heat encountered during use. Although various types of thread may be contemplated, the fire resistant thread may advantageously comprise aramid fibers and/or carbon fibers.

A third aspect of the invention involves the provision of a laminated structural fire protection material. This material is made up of one or more structural layers and one or more fire protection layers bonded to the structural layer(s). The fire protection layer(s) may be of the type described above, and the bond between the structural layer(s) and the fire protection layer(s) may be formed by the silicone based fire resistant coating. In a preferred embodiment of the laminate the structural layer is made from a material selected from the group comprising plywood, MDF, metals and plastics.

Finally, the invention provides a method of extinguishing a burning object. This method comprises the steps of (a) providing an impermeable fire protection blanket having a central part and a peripheral edge part, (b) arranging the fire protection blanket over the burning object such that the peripheral edge part contacts an area surrounding the burning object, (c) smothering the fire, and (d) removing the fire protection blanket from the object.

The fire protection blanket may have a peripheral edge part that is relatively lighter than the central part and that may be sucked tightly against the area surrounding the burning object so as to provide an airtight seal that will assist in smothering the fire.

The central part of the fire protection blanket preferably has a surface area that is at least as great as a combined surface area of the top and sides of the burning object. And the fire protection blanket may be arranged such that the central part substantially covers the top and sides of the burning object while the peripheral edge part lies on the area surrounding the burning object. By covering the burning object with the thicker and more durable central part of the blanket, smothering of the fire is more effective, while the service life of the blanket is increased.

### BRIEF DESCRIPTION OF THE DRAWINGS

These and other features and advantages of the invention will become apparent from the following description of some non-limiting exemplary embodiments. In this description reference will be made to the annexed drawings, in which like elements are indicated by reference numerals incremented by 100, and in which:

FIG. 1 is a partly cut-away perspective view of a fire protection layer constructed in accordance with the invention;

FIG. 2 is a partly cut-away perspective view of a laminated structural material in which such a fire protection layer is used;

FIG. 3 is a plan view of a fire protection blanket that includes a number of fire protection layers as shown in FIG. 1;

FIG. 4 is a partly cut-away perspective view of a central part of the fire protection blanket of FIG. 3;

FIG. 5 is a perspective view of a fire protection blanket being arranged over a burning vehicle, and

FIG. 6 is a perspective view of the vehicle covered by the blanket while the fire is being smothered.

### DETAILED DESCRIPTION OF A PREFERRED EMBODIMENT

A fire protection layer 1 is disclosed (FIG. 1). This layer 1 includes a fabric 2 of relatively pliant fibers 3. In the illustrated embodiment these fibers 3 are glass fibers. However, it is also possible to use different fibers for forming the fabric 2, e.g. polyester fibers or cotton fibers. The fire protection layer 1 further includes a fire resistant coating 4. In the illustrated embodiment the fibers 3 are completely embedded in this coating 4, so that the fabric 2 becomes substantially impermeable. The fire resistant coating 4 comprises silicone and may further comprise one or more minerals.

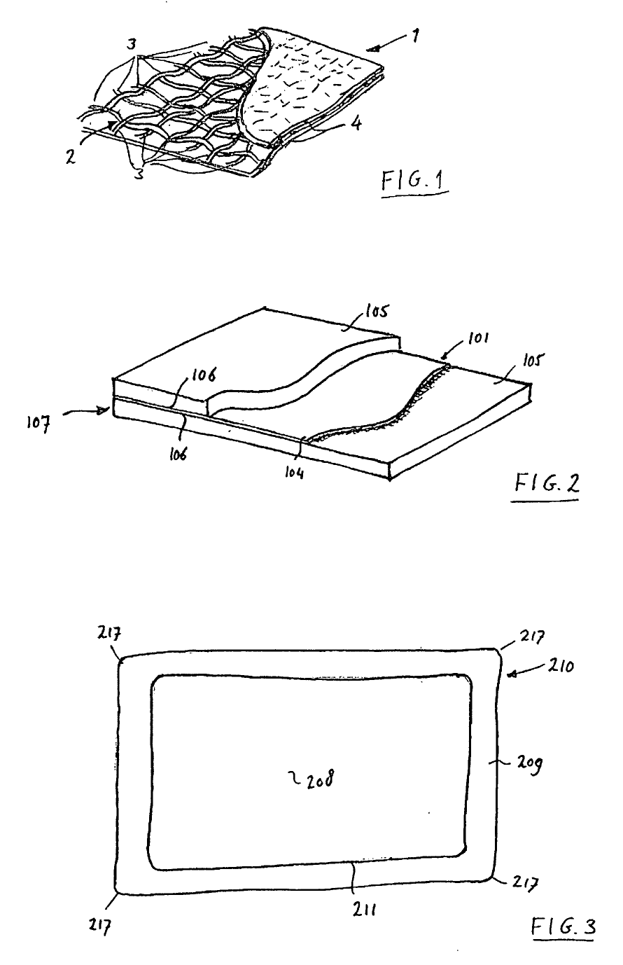

In one embodiment, the fire protection layer is used to render a structural material fire resistant. This is illustrated in FIG. 2, where a laminated structural fire protection material 107 is shown to comprise two structural layers 105 and one fire protection layer 101 sandwiched between these structural layers 105. The three layers 101, 105 are bonded together. In the illustrated embodiment the bonds 106 between the fire protection layer 101 and the structural layer 105 on each side is formed by the silicone based fire resistant coating 104 of the fire protection layer 101. The material of the structural layers 105 is selected as a function of the intended use of the structural laminate 107. For instance, when the structural laminate 107 is to be used in the construction of walls, floors or ceilings in a building, the structural layers 105 may be wood-based, e.g. plywood or MDF. Plywood is also a suitable choice when the structural laminate 107 is intended for building a hull of a vessel. For use in vehicles or aircraft lightweight materials like e.g. aluminum alloys or plastics may be more suitable.

In a presently preferred embodiment the fire protection layer is used in a fire protection blanket 210. As shown in FIG. 3, such a fire protection blanket 210 comprises a central part 208 and a peripheral edge part 209 that are sown together along a border 211. The stitches connecting the central part 208 and the peripheral edge part 209 are made using fire resistant thread that may comprise e.g. aramid fibers and/or carbon fibers, although other fibers may also be used. Both the central part 208 and the peripheral edge part 209 include at least one fire protection layer 201.

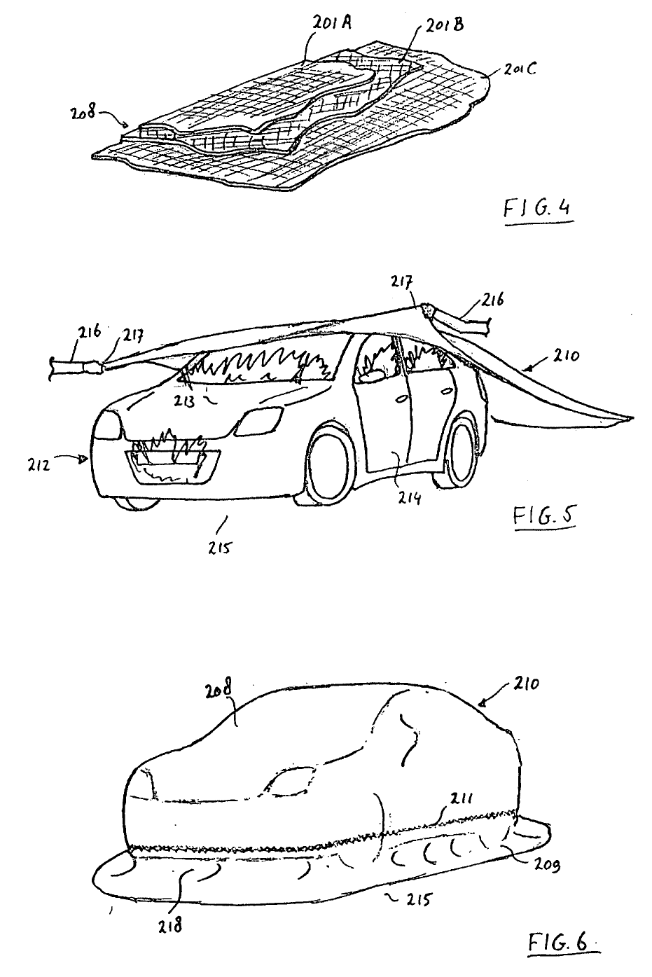

In the illustrated embodiment the peripheral edge part 209 is relatively lighter than the central part 208. This may be achieved in different ways, e.g. by providing the central part 208 with a greater number of fire protection layers 201 than the peripheral edge part 209 or by providing the central part 208 with a fire protection layer 201 that has a more densely woven fabric 202 than the fire protection layer 201 in the peripheral edge part 209. In the illustrated embodiment the central part 208 of the fire protection blanket 210 comprises three fire protection layers 201A-201C (FIG. 4), while the peripheral edge part 209 has only a single fire protection layer 201.

The central part 208 may have a specific mass of at least 150 g/m², preferably at least 300 g/m², and most preferably at least 400 g/m², to ensure good durability when the fire protection blanket 210 is exposed to fire. In the illustrated embodiment the central part 208 has a specific mass of approximately 430 g/m². It has been found that this is sufficient to allow the fire protection blanket 210 to be used at least 10 times in extinguishing a fire, before it has to be replaced. The peripheral edge part 209 may be made lighter, because it will not be directly exposed to fire in the same way as the central part 208.

When a burning object 212, for instance a car has to be extinguished, the first step is to provide a fire protection blanket 201. This blanket 201 may be stored at a central location in a car park or may be part of the equipment carried in a fire engine. The fire protection blanket 201, which will normally be folded or wound into a more or less compact package, is then unfolded or unwound. Subsequently, the blanket 201 is arranged over the burning car 212. This will normally be done by two people (of whom only the arms 216 are shown in FIG. 5) pulling at two corners 217 of the blanket 210.

In the illustrated embodiment the central part 208 of the blanket 201 has a surface area that is at least as great as the combined surface areas of the top 213 and sides 214 of the burning car 212. Consequently, the central part 208 can completely cover the burning car 212 and the peripheral edge part 209 will contact the ground 215 surrounding the burning car 212.

Due to the relatively lightweight structure of the peripheral edge part 209 and the pliant character of the fabric 202, this part 209 will easily conform to the contours of the ground 215. This already provides the beginnings of a seal. While the fire raging under the blanket 210 progressively consumes the oxygen, the pressure under the blanket will fall below ambient pressure. The peripheral edge part 209 will then be sucked tightly onto both the car 212 and the surrounding ground 215, thus perfecting the seal. This is illustrated by the concave shape 218 of the peripheral edge part 209 in FIG. 6. When the oxygen under the blanket 210 has been depleted and the fire has been smothered, the fire protection blanket 210 may be removed from the car 212.

By using the fire protection blanket 210 to smother the fire, there is no need for any water, extinguisher foam or powder. In this way collateral damage to the surrounding area, in particular to other cars parked near the burning car 212 is minimized. Moreover, when the burning car 212 was traveling, the use of the fire protection blanket 210 means that the road may be unblocked immediately after the fire has been extinguished, without any need for major cleaning operations. And since the fire protection blanket 210 relies on suction due to oxygen depletion to provide a seal, rather than on ballast or support structures, it is relatively lightweight, simple to use and cost-effective.

It is to be understood that the above embodiments and description only serve to illustrate the invention and that changes in structure, materials and modes of utilization are possible without departing from the spirit and scope of the invention.

1. A fire protection layer including a fabric of relatively pliant fibers and a fire resistant coating comprising silicone, said coating rendering the fabric substantially impermeable.

2. The fire protection layer of claim 1, wherein the relatively pliant fibers are selected from the group comprising glass fibers, polyester fibers or cotton fibers.

3. The fire protection layer of claim 1, wherein the coating further comprises at least one mineral.

4. A fire protection blanket comprising at least one fire protection layer, said fire protection layer including a fabric of relatively pliant fibers and a fire resistant coating comprising silicone, said coating rendering the fabric substantially impermeable.

5. The fire protection blanket of claim 4, wherein the relatively pliant fibers are selected from the group comprising glass fibers, polyester fibers or cotton fibers.

6. The fire protection blanket of claim 4, wherein the coating further comprises at least one mineral.

7. The fire protection blanket of claim 4, further comprising a central part and a peripheral edge part, wherein the peripheral edge part is relatively lighter than the central part.

8. The fire protection blanket of claim 7, wherein the central part has a greater thickness than the peripheral edge part.

9. The fire protection blanket of claim 8, wherein the central part has a greater number of fire protection layers than the peripheral edge part.

10. The fire protection blanket of claim 7, wherein the fabric of the at least one fire protection layer in the central part has a greater density than that in the peripheral edge part.

11. The fire protection blanket of claim 7, wherein the central part has a specific mass of at least 150 g/m², preferably at least 300 g/m², and most preferably at least 400 g/m².

12. The fire protection blanket of claim 7, wherein the central part is connected to the peripheral edge part by stitches including fire resistant thread.

13. The fire protection blanket of claim 12, wherein the fire resistant thread comprises aramid fibers and/or carbon fibers.

14. A laminated structural fire protection material comprising at least one structural layer and at least one fire protection layer bonded to the at least one structural layer.

15. The laminated structural fire protection material of claim 14, wherein the at least one fire protection layer includes a fabric of relatively pliant fibers and a fire resistant coating comprising silicone, said coating rendering the fabric substantially impermeable, and wherein the bond between the at least one structural layer and the at least one fire protection layer is formed by the silicone based fire resistant coating.

16. The laminated structural fire protection material of claim 15, wherein the structural layer is made from a material selected from the group comprising plywood, MDF, metals and plastics.

17. A method of extinguishing a burning object, comprising the steps of:
a) providing a substantially impermeable fire protection blanket having a central part and a peripheral edge part,
b) arranging the fire protection blanket over the burning object such that the peripheral edge part contacts an area surrounding the burning object,
c) smothering the fire, and
d) removing the fire protection blanket from the object.

18. The method of claim 17, wherein step (a) includes providing a fire protection blanket of which the peripheral edge part is relatively lighter than the central part, and wherein step (c) includes allowing the peripheral edge part to be sucked tightly against the area surrounding the burning object.

19. The method of claim 18, wherein the burning object has a top and sides, wherein step (a) includes providing a fire protection blanket of which the central part has a surface area that is at least as great as a combined surface area of the top and sides of the burning object, and wherein step (b) includes arranging the fire protection blanket such that the central part substantially covers the top and sides of the burning object and the peripheral edge part lies on the area surrounding the burning object.

20. A fire protection blanket comprising a central part including at least one substantially impermeable fire protection layer and a peripheral edge part at least partially surrounding the central part and also including at least one substantially impermeable fire protection layer, wherein the peripheral edge part is relatively lighter than the central part.

21. The fire protection blanket of claim 20, wherein the fire protection layers of the central part and the peripheral edge part each include a fabric of relatively pliant fibers and a fire resistant coating comprising silicone.

22. The fire protection blanket of claim 21, wherein the coatings of the fire protection layers of the central part and the peripheral edge part each further comprise at least one mineral.

23. The fire protection blanket of claim 20, wherein the central part has a surface area that is at least as great as a combined surface area of the top and sides of a passenger car.

24. The fire protection blanket of claim 20, wherein the central part has a greater thickness than the peripheral edge part.

25. The fire protection blanket of claim 20, wherein the fabric of the at least one fire protection layer in the central part has a greater density than the fabric of the at least one fire protection layer in the peripheral edge part.

26. The fire protection blanket of claim 20, wherein the central part has a specific mass of at least 150 g/m², preferably at least 300 g/m², and most preferably at least 400 g/m².
